(19) United States
(12) Patent Application Publication
(10) Pub. No.: US 2011/0298839 A1
(43) Pub. Date: Dec. 8, 2011

(54) DISPLAY APPARATUS AND DISPLAY CONTROL METHOD

(76) Inventor: Atsushi Nakanishi, Osaka (JP)

(21) Appl. No.: 13/145,001

(22) PCT Filed: Jan. 13, 2010
(86) PCT No.: PCT/JP2010/000144

§ 371 Date: Jul. 18, 2011

(30) Foreign Application Priority Data
Jan. 20, 2009 (JP) 2009-009498

(51) Int. Cl. G09G 5/10

(52) U.S. Cl. 345/690

(57) ABSTRACT

The present invention provides a display apparatus and a display control method capable of improving display quality of an image. The display apparatus is provided with an LED backlight (3) that illuminates each of a plurality of divided areas of a screen, a moved amount detection unit (7) that detects a moved amount of an input image in each of the divided areas, an area luminance determination unit (6) that determines a reference luminance value for each of the divided areas, an area luminance time change control unit (8) that determines a luminance control time required to reach the reference luminance value for each of the image areas, according to the moved amount, and an LED backlight drive circuit (4) that drives the LED backlight (3) based on the luminance control time for each of the image areas determined by the area luminance time change control unit (8).

### TECHNICAL FIELD

The present invention relates to a display apparatus that displays images by modulating irradiated light from an illumination light source with a light modulation element, and a display control method for controlling the illumination light source. More particularly, the present invention relates to a display apparatus and a display control method for controlling an illumination light source that illuminates each of a plurality of divided image areas of a screen.

### BACKGROUND ART

Liquid crystal display apparatuses, which use liquid crystal display elements (liquid crystal panel) as light modulation elements, are provided with an illumination light source on the back side thereof, and realize display of arbitrary images by controlling the transmittance of light irradiated from the illumination light source.

Conventionally, liquid crystal display apparatuses control the luminance of a light source for each divided area obtained by dividing a display screen into a plurality of divided areas and arranging at least one light source for each divided area for the purpose of, for example, expanding the dynamic range of display luminance and reducing power consumption.

In a liquid crystal display apparatus employing this type of configuration, the luminance of the light source of each divided area is controlled according to the feature of the image displayed in that divided area. For example, in the case of having a feature such that a pixel that generates a white level display on a black background is present in a certain divided area, the light source of that divided area is driven so as to be switched on according to a white level. In addition, in the case a certain divided area has a feature such that only pixels of a black level display are present, the light source of that divided area is driven so as to be completely switched off (see, for example, Patent Document 1).

In a liquid crystal display apparatus of a configuration described above, the divided areas become large in comparison to the pixels due to restrictions on the number of light sources, the size of the light sources and the like. Consequently, there can be cases in which a white level pixel and a black level pixel are both present in a single divided area. In this case, the light source of that divided area is driven so as to be switched on in accordance with the white level pixel.

An appearance at this time is shown in FIGS. 17A to 17C. FIGS. 17A to 17C are drawings showing images (still images) displayed on a conventional liquid crystal display apparatus. FIG. 17A is a schematic diagram showing an example of an image signal input to a conventional liquid crystal display apparatus, FIG. 17B is a schematic diagram showing the luminance of a light source that illuminates a divided area when the image signal shown in FIG. 17A is input, and FIG. 17C is a schematic diagram showing the image actually displayed on a display screen. It is to be noted that the dotted lines depicted in FIGS. 17A and 17C and the solid lines depicted in FIG. 17B indicate boundaries of the divided areas and are not included in the image signal.

In the image signal shown in FIG. 17A, an divided area 101 contains both a white image 102 composed with white level pixels, and a black image 103 composed with black level pixels. The white image 102 is located in the center of the divided area, while the black image 103 is located in the peripheral area around the white image 102.

In the case where both white level pixels and black level pixels are present in a single divided area, the light source that illuminates the divided area is switched on brightly to display the white level pixels as shown in FIG. 17B. At this time, the black level pixels are displayed black by reducing transmittance of the liquid crystal panel. However, it is difficult to completely reduce the transmittance of liquid crystal display elements to zero. Consequently, a phenomenon of so-called “brightened black” occurs in which light from the brightly illuminating light source leaks to the black level pixels causing the black image 103 to become slightly bright. FIG. 17C illustrates an appearance in which the brightened black is occurring. As shown in FIG. 17C, the black image 103 in the divided area 101, in which both white level pixels and black level pixels are present, is slightly brighter.

Next, a description is provided of the problem that occurs due to the occurrence of this brightened black in a moving image using FIG. 18. FIGS. 18A to 18C are drawings showing images (moving images) displayed on a conventional liquid crystal display apparatus. FIG. 18A is a diagram showing an image displayed in the case where a rectangular image is present in a divided area on the left side of a display screen, FIG. 18B is a diagram showing an image displayed in the case where a rectangular image is present on the boundary between the divided area on the left side of the display screen and a divided area in the center of the display screen, and FIG. 18C is a diagram showing an image displayed in the case where a rectangular image is present in the divided area in the center of the display screen. As shown in FIGS. 18A to 18C, the case is considered in which a white level rectangular image that is smaller than the divided area is displayed on a black background, and the rectangular image moves rightward. It is to be noted that the dotted lines depicted in FIGS. 18A to 18C indicate boundaries of the divided areas, and are not included in the image signal.

As shown in FIG. 18A, when a rectangular image 203 is within a divided area 201 on the left side, the light source of the divided area 201 is switched on, while the light sources of divided areas other than the divided area 201 are switched off. Consequently, a black background image 204 surrounding the rectangular image 203 in the divided area 201 becomes slightly brighter, and the brightened black occurs in the divided area 201 that contains the rectangular image 203.

Next, as shown in FIG. 18B, when rectangular image 203 straddles the boundary between the divided area 201 and a divided area 202 adjacent to the divided area 201 on the right side thereof as a result of the rectangular image moving rightward, the light sources of both of the divided areas 201 and 202 are switched on. This causes the black background image 204 surrounding the rectangular image 203 in the divided area 201 and a black background image 205 surrounding the rectangular image 203 in the divided area 202 to become slightly brighter. As a result, the brightened black occurs in both of the divided areas 201 and 202 that contain the rectangular image 203, and the area of the brightened black portion becomes larger.

As shown in FIG. 18C, when the rectangular image 203 moves completely into the central divided area 202, the light source of the divided area 201 on the left side is switched off, and the light source of the central divided area 202 is switched on. Consequently, the black background image 205 surrounding the rectangular image 203 in the divided area 202 becomes slightly brighter, and the brightened black occurs only in the central divided area 202 that contains the rectangular image 203.

In this manner, when an image moves straddling a boundary between a plurality of divided areas, the area of the brightened black portion described above changes at the instant the image straddles the boundary between the plurality of divided areas. Consequently, with the movement of the image, the portion where the brightened black occurs moves intermittently in contrast to the image moving smoothly. Since this unnatural movement of the brightened black portion is readily visible, display quality of the image decreases.

With respect to the above-mentioned problem, Patent Document 1 attempts to set a pixel area which is obtained by enlarging a pixel to actually be displayed at a white level by a predetermined area, and designate a light source of the divided area corresponding to the pixel to actually be displayed at a white level and a light source of the divided area corresponding to the enlarged pixel area as targets of driving.

However, in Patent Document 1 as well, when the enlarged pixel area straddles a boundary between a plurality of divided areas, the same phenomenon as the problem described above occurs. Consequently, the problem described above is still unresolved.

In addition, in the case where an object straddles a boundary between a plurality of divided areas, the brightness of the backlight changes suddenly and appears unnaturally in the form of a “halo” (the leaked light of the backlight from around the object). Thus, there is also a problem of a decrease in display quality. With respect to this problem, a method may be employed in which sudden changes in luminance are inhibited with a low pass filter (LPF) and the like in order to alleviate changes in the luminance of the backlight for each divided area.

In this case, however, in a scene such that a flash from a camera and the like suddenly flashes, the luminance of the backlight for representing the light from the flash is unable to be secured adequately due to the effect of the LPF, thereby resulting in the problem of being unable to adequately represent the light from the flash.
Patent Document 1: Japanese Patent Application Laid-open No. 2001-142409

### SUMMARY OF THE INVENTION

The present invention is made to solve the problem described above, and an object of the present invention is to provide a display apparatus and a display control method capable of improving display quality of an image.

A display apparatus according to one aspect of the present invention is provided with an illumination light source that illuminates each of a plurality of divided image areas of a screen, a moved amount detection unit that detects a moved amount of an input image in each of the image areas, a reference luminance value determination unit that determines a reference luminance value for each of the image areas, a luminance control time determination unit that determines a luminance control time required to reach the reference luminance value determined by the reference luminance value determination unit for each of the image areas, according to the moved amount detected by the moved amount detection unit, and a drive unit that drives the illumination light source based on the luminance control time for each of the image areas determined by the luminance control time determination unit.

According to this configuration, the illumination light source illuminates each of a plurality of divided image areas of a screen. The moved amount detection unit detects a moved amount of an input image in each of the image areas. The reference luminance determination unit determines a reference luminance value for each of the image areas. The luminance control time determination unit determines a luminance control time required to reach the reference luminance value determined by the reference luminance value determination unit for each of the image areas, according to the moved amount detected by the moved amount detection unit. The drive unit drives the illumination light source based on the luminance control time for each of the image areas determined by the luminance control time determination unit.

According to the present invention, the luminance control time required to reach the determined reference luminance value is determined for each of the image areas according to the detected moved amount. Thus, it is possible to prevent the brightened black by inhibiting rapid changes in luminance value of the illumination light in the case where the input image is a still image, and to change the luminance value of the illumination light according to the moved amount in the case where the input image is a moving image having a large moved amount, thereby making it possible to improve display quality of the image.

Objects, characteristics and advantages of the present invention will be made clearer by the following detailed description and appended drawings.

### BRIEF DESCRIPTION OF THE DRAWINGS

FIG. 1 is a block diagram showing the entire configuration of a liquid crystal display apparatus according to a first embodiment of the present invention.

FIG. 2 is a block diagram showing a detailed configuration of an area luminance time change control unit shown in FIG. 1.

FIG. 3 is a first flow chart showing an example of the operation of the liquid crystal display apparatus shown in FIGS. 1 and 2.

FIG. 4 is a second flow chart showing an example of the operation of the liquid crystal display apparatus shown in FIGS. 1 and 2.

FIG. 5 is a block diagram showing a detailed configuration of an area luminance time change control unit in a liquid crystal display apparatus of a variation of the first embodiment.

FIGS. 6A and 6B are charts indicating a relationship between a luminance control time and brightness (luminance).

FIGS. 7A and 7B are charts indicating a different relationship between the luminance control time and the brightness (luminance).

FIG. 8 is a flow chart showing an example of the operation of a liquid crystal display apparatus in the variation of the first embodiment.

FIG. 9 is a schematic diagram depicting an object moving across a boundary between the divided areas in a certain input image.

FIG. 10 is a diagram showing the locations of the object for each frame of the input image of FIG. 9 and the luminance value of each divided area in those frames.

FIG. 11 is a chart indicating the luminance control time of LED backlight in the divided area in the central portion of the screen shown in FIG. 10.

FIG. 12 is a schematic diagram depicting an object in a certain input image moving without crossing a boundary between the divided areas.

FIG. 13 is a diagram showing the locations of the object for each frame of the input image of FIG. 12 and the luminance value of each divided area in those frames.

FIG. 14 is a chart indicating the luminance control time of LED backlight in the divided area in the central portion of the screen shown in FIG. 13.

FIG. 15 is a block diagram showing a detailed configuration of the area luminance time change control unit in a liquid crystal display apparatus of a second embodiment.

FIG. 16 is a flow chart showing an example of the operation of the liquid crystal display apparatus of the second embodiment.

FIGS. 17A to 17C are drawings showing images (still images) displayed on a conventional liquid crystal display apparatus.

FIGS. 18A to 18C are drawings showing images (moving images) displayed on a conventional liquid crystal display apparatus.

### BEST MODE FOR CARRYING OUT THE INVENTION

The following provides a description of embodiments of the present invention while referring to the appended drawings. It is to be noted that the following embodiments are merely specific examples of the present invention and are not intended to limit the technical scope of the present invention.

### First Embodiment

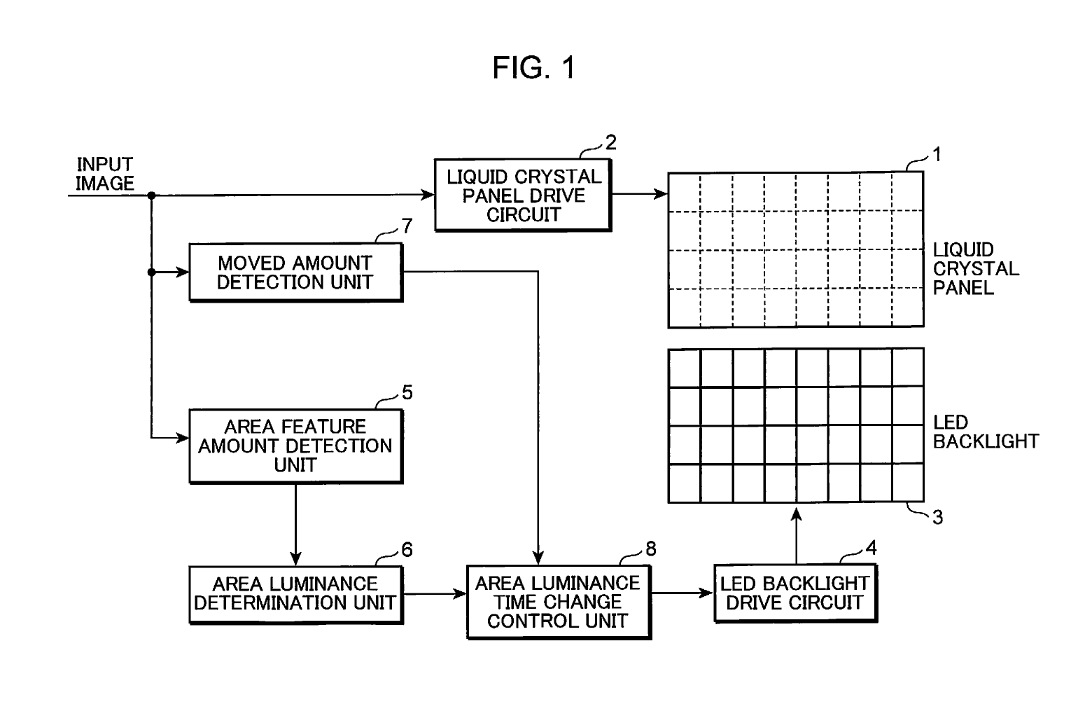

First, a description is provided of a liquid crystal display apparatus according to a first embodiment of the present invention. FIG. 1 is a block diagram showing the entire configuration of a liquid crystal display apparatus according to the first embodiment of the present invention. The liquid crystal display apparatus shown in FIG. 1 is provided with a liquid crystal panel 1, a liquid crystal panel drive circuit 2, an LED (Light Emitting Diode) backlight 3, an LED backlight drive circuit 4, an area feature amount detection unit 5, an area luminance determination unit 6, a moved amount detection unit 7, and an area luminance time change control unit 8.

Although not shown in the drawing, the liquid crystal panel 1 is provided with a plurality of gate lines, a plurality of source lines, switching elements and a plurality of pixel cells, a plurality of pixels are arranged in the form of a matrix at the intersections of the plurality of source lines and the plurality of gate lines, and a single scanning line is composed of a single line of pixels in the horizontal direction. The pixels are driven by supplying pixel signals to the plurality of source lines from the liquid crystal panel drive circuit 2, and supplying gate pulses serving as scanning signals to the plurality of gate lines from the liquid crystal panel drive circuit 2. The liquid crystal panel drive circuit 2 drives each pixel of the liquid crystal panel 1 based on an input image. As indicated with the dotted lines in FIG. 1, the display screen of the liquid crystal panel 1 is divided into a plurality of divided areas.

The LED backlight 3 irradiates illumination light for displaying an image to the liquid crystal panel 1 from the back side thereof. The LED backlight 3 is divided into a plurality of divided areas in the same manner as the liquid crystal panel 1. The LED backlight 3 illuminates each of the divided areas of the screen. Each of the divided areas of the LED backlight 3 illuminates a divided area at the same location on the liquid crystal panel 1. At least one light source is respectively arranged in each of the divided areas of the LED backlight 3. Specifically, the LED backlight 3 is provided with a plurality of light sources (LED) that illuminate the plurality of divided areas, respectively. A white LED using a phosphor, or an RGB LED that obtains white light by using three colors of LED composed of red (R), green (G) and blue (B), is used as a light source, for example.

The LED backlight drive circuit 4 drives the LED belonging to each divided area. A plurality of LED within a single divided area are respectively driven so as to have the same light emission luminance. The LED backlight drive circuit 4 drives the luminance of each divided area independently. Although not shown in the drawing, the LED in each of the divided areas of the LED backlight 3 are connected with the LED backlight drive circuit 4 by control lines.

The area feature amount detection unit 5, after an input image is divided into a plurality of divided areas in the same manner as the liquid crystal panel 1 (LED backlight 3), detects a feature amount of images within each of the divided areas. The area feature amount detection unit 5 detects a feature amount of each of the divided areas of the input image. Peak values of pixels within a divided area or mean values of pixels within a divided area are used as the detected feature amount.

The area luminance determination unit 6 determines a luminance value (reference luminance value) of LED for each divided area based on a feature amount detected by the area feature amount detection unit 5. The area luminance determination unit 6 determines a luminance value of LED based on input-output characteristics in the case of using the feature amount detected by the area feature amount detection unit 5 as an input and using the luminance of LED as an output. The input-output characteristics may be linear characteristics in the manner of the luminance of LED increasing linearly with respect to increase of the feature amount, or characteristics in the manner of a gamma curve in which output is raised with respect to a halftone input. Further, the area luminance determination unit 6 is able to have arbitrary input-output characteristics according to the luminance at which each divided area is made to emit light with respect to the detected feature amount. Furthermore, input-output characteristics are stored in advance in the form of a table, for example.

The moved amount detection unit 7 detects a moved amount of an input image for each of the divided areas. The moved amount detection unit 7 detects a motion vector in each of divided microareas obtained by further dividing each divided area, and detects a moved amount of the divided area based on the detected motion vector.

The moved amount detection unit 7 analyzes the input image, and detects the degree to which an object and the like in an input image have moved between image frames. In other words, the moved amount detection unit 7 detects so-called motion vectors. Specifically, an input image is input into a frame memory for each frame, and the frame memory outputs the input image of the previous frame. The moved amount detection unit 7 analyzes motion in each of microareas obtained by dividing an input image corresponding to a single frame (input image) and composed of a plurality of pixels. It is to be noted that the microareas are areas smaller than the divided areas of the liquid crystal panel 1 and the LED backlight 3. For example, the microareas may be composed of a single pixel or may be composed of four pixels in a 2×2 matrix.

Here, motion analysis is carried out by searching for a microarea in the input image of the previous frame that has a pixel value similar to the pixel values of each microarea of the input image of the current frame. The moved amount detection unit 7 designates a microarea on the input image of the previous frame that is at the same location as the target microarea of the input image of the current frame as a central microarea, and searches for the microarea that has the largest correlation with the target microarea of the input image of the current frame while sequentially scanning around the central microarea. The moved amount detection unit 7 detects a distance between the microarea having the largest correlation found as a result of the search and the central microarea as the moved amount. The moved amount detection unit 7 detects the moved amount for each microarea. The moved amount detection unit 7 calculates a mean value of the moved amount of a plurality of microareas belonging to each divided area, and outputs the calculated mean value as the moved amount of each divided area.

Furthermore, there may be cases in which a microarea having the largest correlation with the target microarea is not found as a result of searching. For example, in the case where the scene of an image changes, in the case where an object suddenly appears in an image frame, or in the case where an object suddenly disappears from an image frame, a microarea having the largest correlation with the target microarea may not be found, and thus, the moved amount detection unit 7 cannot detect a motion vector (moved amount). Consequently, in the case where a microarea having the largest correlation with the target microarea is not found, the moved amount detection unit 7 outputs a motion vector undetectable signal indicating to the effect that a motion vector (moved amount) of the target microarea is unable to be detected.

Furthermore, the method used to detect a motion vector (moved amount) described here is only one example, and the present invention is not limited to this detection algorithm, and any arbitrary motion vector detection method can be used.

The area luminance time change control unit 8 determines a luminance control time required to reach the luminance value determined by the area luminance determination unit 6 for each image area, according to the moved amount detected by the moved amount detection unit 7. The area luminance time change control unit 8 uses information relating to the moved amount which is output from the moved amount detection unit 7 to control time-based changes in luminance of the LED of each divided area. The area luminance time change control unit 8 controls so that time-based changes in luminance become slower for divided areas in which the moved amount detected by the moved amount detection unit 7 is small, and time-based changes in luminance become faster for divided areas in which the moved amount detected by the moved amount detection unit 7 is large. In other words, processing in the area luminance time change control unit 8 can be said to be processing in which a low pass filter is applied to changes in luminance in the direction of time, and the characteristics of the low pass filter can be varied according to the moved amount.

The area luminance time change control unit 8 determines whether or not the moved amount detected by the moved amount detection unit 7 is equal to or greater than a predetermined value. In the case where the moved amount detected by the moved amount detection unit 7 is determined not to be equal to or greater than a predetermined value, the area luminance time change control unit 8 makes the luminance control time required to reach the reference luminance value longer than the luminance control time required to reach the reference luminance value in the case of having determined the moved amount detected by the moved amount detection unit 7 to be equal to or greater than a predetermined value. Furthermore, the predetermined value that is compared with the moved amount is, for example, a moved amount that makes it possible to determine whether an image in a divided area is a still image or a moving image.

In addition, in the case where the moved amount detected by the moved amount detection unit 7 has been determined to be equal to or greater than a predetermined value, the area luminance time change control unit 8 counts motion vectors within a divided area that cannot be detected by the moved amount detection unit 7 as undetectable motion vectors, and determines whether or not the number of undetectable motion vectors is equal to or greater than a predetermined value. In the case where the number of undetectable motion vectors is determined not to be equal to or greater than a predetermined value, the area luminance time change control unit 8 makes the luminance control time required to reach the reference luminance value longer than the luminance control time required to reach the reference luminance value in the case of having determined the number of undetectable motion vectors to be equal to or greater than a predetermined value. Furthermore, the predetermined value that is compared with the number of undetectable motion vectors is the number of undetectable motion vectors that enables detection of at least one of a change in the scene of an image, the sudden appearance of an object in an image frame, and the sudden disappearance of an object from an image frame.

Furthermore, the LED backlight drive circuit 4 drives the LED backlight 3 based on the luminance control time for each image area determined by the area luminance time change control unit 8.

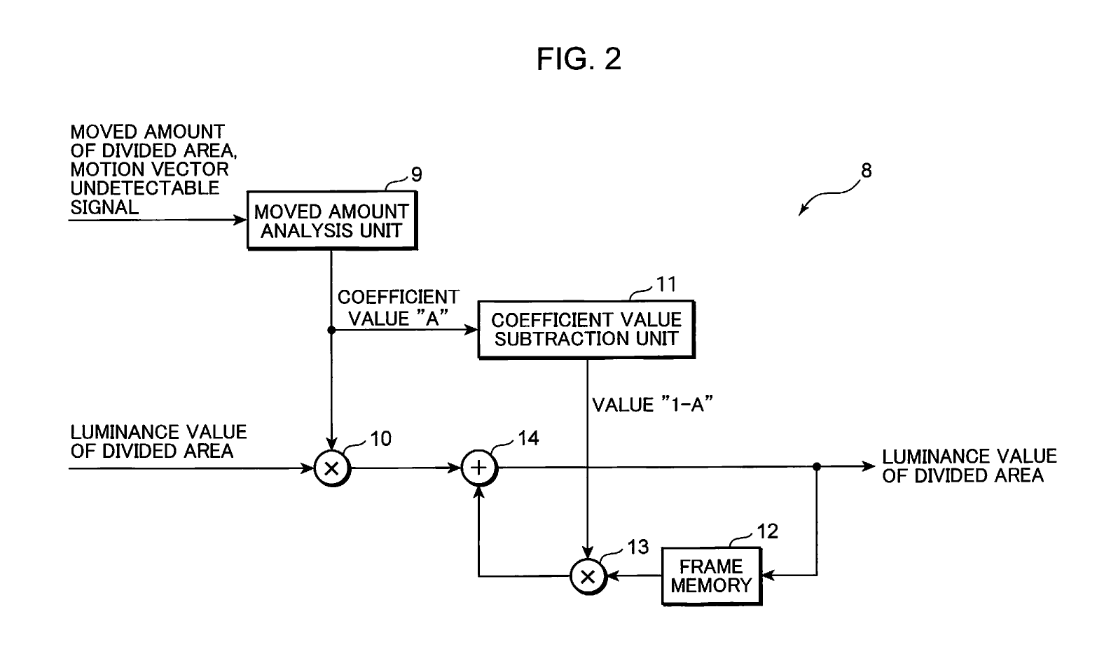

Here, a detailed configuration of the area luminance time change control unit 8 is described using FIG. 2.

FIG. 2 is a block diagram showing the detailed configuration of the area luminance time change control unit shown in FIG. 1. The area luminance time change control unit 8 shown in FIG. 2 is provided with a moved amount analysis unit 9, a first multiplier 10, a coefficient value subtraction unit 11, a frame memory 12, a second multiplier 13 and an adder 14.

The moved amount analysis unit 9 analyzes the moved amount for each divided area output from the moved amount detection unit 7, and outputs a coefficient value “A” for arithmetic processing in a latter stage. The moved amount analysis unit 9 determines whether or not the moved amount of a divided area detected by the moved amount detection unit 7 is equal to or greater than a predetermined threshold value. In the case where the moved amount of the divided area is determined to be smaller than the threshold value, the moved amount analysis unit 9 determines that the image in the divided area is not moving, and outputs “0” as the coefficient value “A”.

On the other hand, in the case where the moved amount of the divided area is determined to be equal to or greater than the threshold value, the moved amount analysis unit 9 counts the number of motion vector undetectable signals which are output from the moved amount detection unit 7 and indicate that a motion vector cannot be detected, and determines whether or not the number of motion vector undetectable signals is equal to or greater than a predetermined threshold value. In the case where the number of motion vector undetectable signals has been determined to be equal to or greater than the threshold value, the moved amount analysis unit 9 outputs “1” as the coefficient value “A”.

On the other hand, in the case where the number of motion vector undetectable signals has been determined to be less than the threshold value, the moved amount analysis unit 9 outputs a value of “0.1” to “0.9” proportional to the magnitude of the moved amount of the divided area as the coefficient value “A”. Furthermore, the moved amount analysis unit 9 outputs the coefficient value “A” to the first multiplier 10 and the coefficient value subtraction unit 11.

Furthermore, in the above description, a value of “0.1” to “0.9” proportional to the moved amount of the divided area is output as the coefficient value “A”. However, a characteristic may also be imparted other than a characteristic that is proportional to the moved amount of the divided area, provided that the characteristic has a relationship in which the coefficient value “A” also increases with an increase in the moved amount of the divided area.

The first multiplier 10 multiples a divided area luminance value determined by the area luminance determination unit 6 by the coefficient value “A” output from the moved amount analysis unit 9. The coefficient value subtraction unit 11 outputs a value “1−A”, which is obtained by subtracting the coefficient value “A” output from the moved amount analysis unit 9 from “1”, to the second multiplier 13. The frame memory 12 stores the luminance value of each divided area of the input image of the previous frame. The second multiplier 13 multiplies the luminance value of the divided area of the input image of the previous frame stored in the frame memory 12 by the value “1−A” output from the coefficient value subtraction unit 11.

The adder 14 adds the product of the divided area luminance value and the coefficient value “A” output from the first multiplier 10 to the product of the divided area luminance value of the input image of the previous frame and the value of “1−A” output from the second multiplier 13. In addition to outputting the result of addition to the frame memory 12 as the divided area luminance value, the adder 14 outputs the result of addition to the LED backlight drive circuit 4 as the divided area luminance value. The frame memory 12 stores the divided area luminance value output from the adder 14.

In the configuration described above, the coefficient value “A” means a weight with respect to the luminance value of a divided area of an input frame. As the coefficient value “A” becomes larger, the weight with respect to the luminance value of a divided area of an input frame increases, while conversely, the weight with respect to the luminance value of a divided area of the previous frame becomes smaller. Thus, the output luminance value approaches the luminance value of the divided area of the input frame. Specifically, the larger the coefficient “A” becomes, the easier the time-based change of the luminance value of the divided area becomes, and the time-based change becomes faster. Conversely, as the coefficient “A” becomes smaller, the time-based change of the luminance value of the divided area is inhibited, and the time-based change becomes slower. In other words, the luminance value of the divided area is controlled so as to change faster as the moved amount in each divided area becomes greater, and is controlled so as to change slower as the moved amount in each divided area becomes smaller.

This operation is an operation that applies a low pass filter to changes in divided area luminance in the direction of time. In the above description, an IIR (infinite impulse response) filter is used for the low pass filter. The area luminance time change control unit 8 changes the coefficient of the IIR filter according to the moved amount of the image within each divided area to control the characteristics thereof as the low pass filter, and controls the speed of the time-based change in the luminance value in each divided area.

In addition, in the case where a motion vector is unable to be detected in an divided area, it is contemplated that the image scene has changed, an object has appeared in that divided area or an object has disappeared from that divided area. Thus, the area luminance time change control unit 8 immediately changes the luminance value of that divided area. Consequently, the moved amount analysis unit 9 outputs a “1” for the coefficient value “A” so as to immediately reflect the luminance value of the divided area of the input frame.

In this manner, in the case where the moved amount detected by the moved amount detection unit 7 has been determined not to be equal to or greater than a predetermined value, the area luminance time change control unit 8 sets luminance control time based on a reference luminance value of each divided area of the input image of the previous frame stored in the frame memory 12. In addition, in the case where the moved amount detected by the moved amount detection unit 7 has been determined to be equal to or greater than a predetermined value, the area luminance time change control unit 8 sets luminance control time based on the reference luminance value of each divided area of the current input image and the reference luminance value of each divided area of the input image of the previous frame stored in the frame memory 12.

In addition, in the case where the number of undetectable motion vectors has been determined to be equal to or greater than a predetermined value, the area luminance time change control unit 8 sets luminance control time based on the reference luminance value of each divided area of the current input image. Moreover, in the case where the number of undetectable motion vectors has been determined not to be equal to or greater than the predetermined value, the area luminance time change control unit 8 sets luminance control time based on the reference luminance value of each divided area of the current input image and the reference luminance value of each divided area of the input image of the previous frame stored in the frame memory 12.

As a result of this processing that is carried out when a motion vector is unable to be detected, when an image has been input in which, for example, a flash of a camera has flashed for a moment on a dark background, the momentary light of the flash can be faithfully brightly reproduced by instantly increasing the luminance of the divided area in which the flash is displayed and instantly switching off. Accordingly, it becomes possible to satisfy both of control of luminance value in a divided area in accordance with the moved amount and response to an instant change in luminance value in a divided area.

In this manner, the speed of time-based change in the luminance value of a divided area is controlled by applying a low pass filter to the luminance value of a divided area in the direction of time, and controlling the characteristics of the low pass filter based on the magnitude of the moved amount and the presence or absence of a motion vector.

Furthermore, in the description above. although the IIR filter is used as the low pass filter in the direction of time in the area luminance time change control unit 8, the present invention is not limited to this configuration. Other configurations can be employed provided that the filter functions as a low pass filter in the direction of time. In addition, although the moved amount analysis unit 9 calculates a mean value of the moved amount within the divided area, the present invention is not limited thereto. Any arbitrary method can be employed provided, such as calculating the sum of the moved amount, that outputting the coefficient value “A” which increases in value according to the magnitude of the moved amount within the divided area.

Furthermore, although an example of using an LED as the light source has been described in the above embodiment, the present invention is not limited thereto, but rather a light source other than an LED can also be employed provided images are divided into a plurality of divided areas and the luminance of the respective divided areas can be independently controlled.

Furthermore, although motion vector detection is used as the method for detecting a moved amount of an image in a divided area in the above embodiment, the present invention is not limited thereto. Other methods can be employed provided that it is possible to detect a moved amount in a divided area. For example, a method of estimating a moved amount of an image in a divided area by analyzing the change in luminance value of each divided area for each image frame and the like are conceivable.

Furthermore, although a configuration is employed in which input images are input directly to the liquid crystal panel drive circuit 2 in the above embodiment, the present invention is not limited thereto. A configuration may be employed in which image signals are corrected according to the luminance of the light source of each divided area, so that the brightness of those portions in which the light source has become dark is compensated with the image signals.

In addition, in the present embodiment, a divided area corresponds to an example of an image area, the LED backlight 3 corresponds to an example of an illumination light source, the moved amount detection unit 7 corresponds to an example of a moved amount detection unit, the area luminance determination unit 6 corresponds to an example of a reference luminance value determination unit, the area luminance time change control unit 8 corresponds to an example of a luminance control time determination unit, the LED backlight drive circuit 4 corresponds to an example of a drive unit, and the frame memory 12 corresponds to an example of a storage unit.

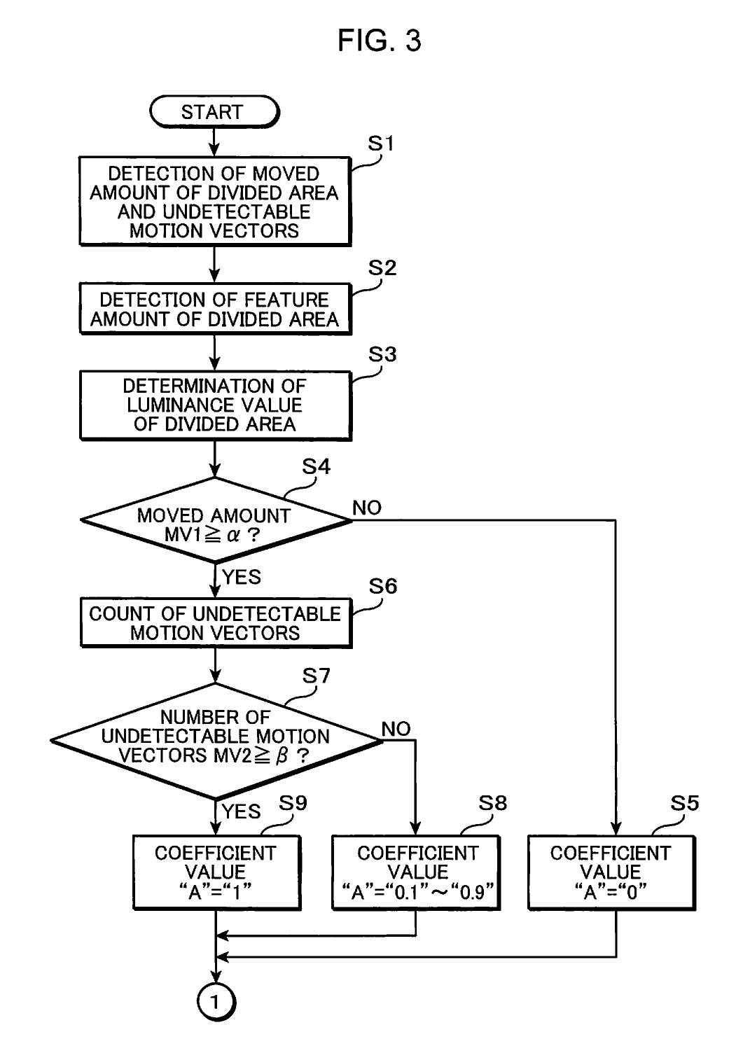

Next, a description is provided, with reference to FIG. 3 and subsequent drawings, of a specific display control method of the liquid crystal display apparatus described above. First, a display control method of the liquid crystal display apparatus shown in FIG. 1 is described with reference to FIGS. 3 to 7.

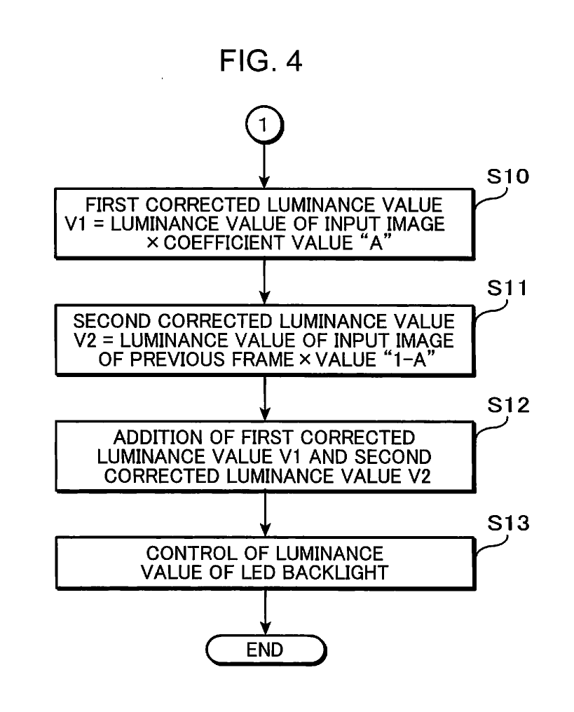

FIGS. 3 and 4 are flow charts showing an example of the operation of the liquid crystal display apparatus shown in FIGS. 1 and 2.

First, the moved amount detection unit 7 detects the moved amount of motion vectors in each of a plurality of divided areas obtained by dividing a display screen, and undetectable motion vectors for which the moved amount is not detected in each divided area from an input image signal (Step S1). Furthermore, the moved amount of the divided areas may be a mean value of the moved amount of a plurality of microareas that compose the divided areas or the total value of the moved amount of a plurality of microareas that compose the divided areas. In addition, the moved amount detection unit 7 detects undetectable motion vectors for which the moved amount is not detected from among motion vectors of a plurality of microareas that compose the divided areas. The moved amount detection unit 7 outputs a motion vector undetectable signal indicating that a motion vector cannot be detected to the area luminance time change control unit 8.

Next, the area feature amount detection unit 5, after the input image is divided into a plurality of divided areas in the same manner as the liquid crystal panel 1 (LED backlight 3), detects features of the image in each divided area (Step S2). Furthermore, the area feature amount detection unit 5 detects the peak value of each pixel in the divided areas as the feature amount.

Next, the area luminance determination unit 6 determines the luminance value of the LED of each divided area of the LED backlight 3 based on the feature amount detected by the area feature amount detection unit 5 (Step S3). More specifically, the area luminance determination unit 6 preliminarily stores a table that correlates the feature amount and the luminance value. The area luminance determination unit 6 refers to the table and extracts the luminance value corresponding to the feature amount detected by the area feature amount detection unit 5. Furthermore, the table has input-output characteristics such that the luminance value increases linearly as the feature amount increases.

Next, the moved amount analysis unit 9 in the area luminance time change control unit 8 determines whether or not a moved amount MV1 of motion vectors of each divided area detected in Step S1 is equal to or greater than a predetermined threshold value α determined in advance (Step S4). Here, in the case where the moved amount MV1 of a divided area has been determined to be smaller than the predetermined threshold value α, that is, in the case where the image in the divided area is a still image (NO in Step S4), the moved amount analysis unit 9 assigns “0” as the coefficient value “A” (Step S5). Furthermore, a configuration can also be employed in which “1” is assigned as the coefficient value “A”.

On the other hand, in the case where the moved amount MV1 of a divided area has been determined to be equal to or greater than the predetermined threshold value α, that is, in the case where the image in the divided area is a moving image (YES in Step S4), the moved amount analysis unit 9 counts the motion vector undetectable signals which are output from the moved amount detection unit 7 and indicate that the motion vectors cannot be detected. As a result, the moved amount analysis unit 9 counts undetectable motion vectors for which the moved amount is not detected in the divided area (Step S6).

Next, the moved amount analysis unit 9 determines whether or not the number of the undetectable motion vectors MV2 in each divided area is equal to or greater than a predetermined threshold value β (Step S7). Here, in the case where the number of the undetectable motion vectors MV2 is determined to be less than the predetermined threshold value β, that is, in the case where a change in the image scene and the like have not occurred (NO in Step S7), the moved amount analysis unit 9 assigns a value of “0.1” to “0.9” as the coefficient value “A” according to the magnitude of the moved amount (Step S8).

On the other hand, in the case where the number of the undetectable motion vectors MV2 has been determined to be equal to or greater than the predetermined threshold value β, that is, in the case where a switch in the image scene and the like have occurred (YES in Step S7), the moved amount analysis unit 9 assigns “1” as the coefficient value “A” (Step S9). Processing starting with Step S10 is described with reference to FIG. 4.

Next, the first multiplier 10 of the area luminance time change control unit 8 calculates a first corrected luminance value V1 by multiplying the coefficient value “A” set for each divided area in Steps S5, S8 and S9 by the luminance value of each divided area of the input image signal (Step S10).

For example, in the case where “0” is set as the coefficient value “A” in Step S5, the first multiplier 10 outputs “0” as the first corrected luminance value V1 as a result of multiplying the luminance value of the input image by the coefficient value “A”. On the other hand, in the case where “1” is set as the coefficient value “A” in Step S9, the first multiplier 10 directly outputs the input luminance value as the first corrected luminance value V1 as a result of multiplying the luminance value of the input image by the coefficient value “A”. In addition, in the case where “0.1” to “0.9” is set as the coefficient value “A” in Step S8, the first multiplier 10 outputs the value obtained by multiplying the coefficient value of “0.1” to “0.9” by the luminance value of each divided area of the input image signal as the first corrected luminance value V1.

Next, the second multiplier 13 of the area luminance time change control unit 8 calculates a second corrected luminance value V2 by multiplying the value “1−A” obtained by subtracting the coefficient value “A” set for each divided area in Steps S5, S8 and S9 from “1” by at least the luminance value of each divided area of the image signal of the previous frame stored in the frame memory 12 of the area luminance time change control unit 8 (Step S11).

For example, in the case where “0” is set as the value “A” in Step S5, the first multiplier 10 directly outputs the luminance value of the divided area of the image signal of the previous frame as the second corrected luminance value V2 as a result of multiplying the value obtained by subtracting the coefficient value “0” from “1” by the luminance value of the input image of the previous frame. On the other hand, in the case where “1” is set as the coefficient value “A” in Step S9, “0” is output as the second corrected luminance value V2 as a result of multiplying the value obtained by subtracting the coefficient value “1” from “1” by the luminance value of the input image of the previous frame. In addition, in the case where “0.1” to “0.9” is set as the coefficient value “A” in Step S8, the value, which is obtained by multiplying the value obtained by subtracting the coefficient value “0.1” to “0.9” from “1” by the luminance value of the divided area of the image signal of the previous frame, is output as the second corrected luminance value V2.

Next, the adder 14 of the area luminance time change control unit 8 outputs the corrected luminance value of the input image signal as the divided area luminance value by adding the first corrected luminance value V1 calculated in Step S10 to the second corrected luminance value V2 calculated in Step S11 (Step S12). The adder 14 outputs the calculated divided area luminance value to the LED backlight drive circuit 4 and the frame memory 12.

Next, the LED backlight drive circuit 4 controls the luminance value of the LED of each divided area based on the divided area luminance value calculated in Step S12 (Step S13).

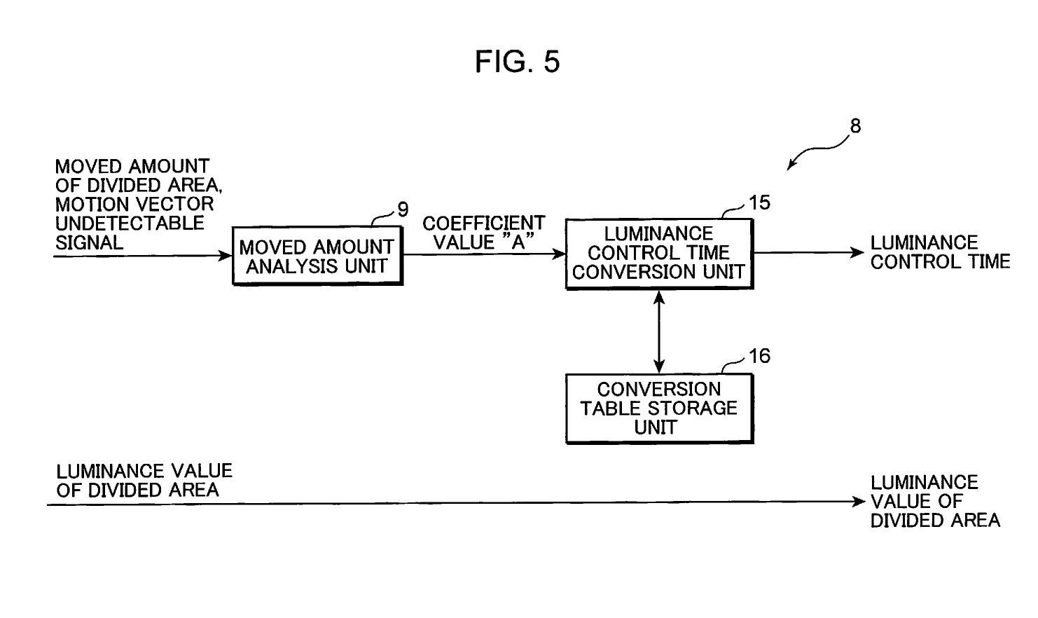

Next, a description is provided of a variation of the first embodiment. FIG. 5 is a block diagram showing a detailed configuration of the area luminance time change control unit 8 in a liquid crystal display apparatus that is a variation of the first embodiment. Furthermore, the entire configuration of the liquid crystal display apparatus of this variation of the first embodiment is omitted since it is the same as the liquid crystal display apparatus shown in FIG. 1. In addition, the same reference symbols are used in FIG. 5 to indicate those constituents that are the same as those of the area luminance time change control unit 8 shown in FIG. 2, and descriptions thereof are omitted.

The area luminance time change control unit 8 shown in FIG. 5 is provided with the moved amount analysis unit 9, a conversion table storage unit 15 and a luminance control time conversion unit 16.

The conversion table storage unit 15 stores a conversion table that correlates the coefficient value “A” with a luminance control time required for the luminance value of the LED backlight 3 to reach the luminance value determined by the area luminance determination unit 6. The luminance control time is set so as to become shorter as the coefficient value “A” becomes larger.

The luminance control time conversion unit 16 converts the coefficient value “A” calculated by the moved amount analysis unit 9 to the luminance control time by referring to the conversion table stored in the conversion table storage unit 15.

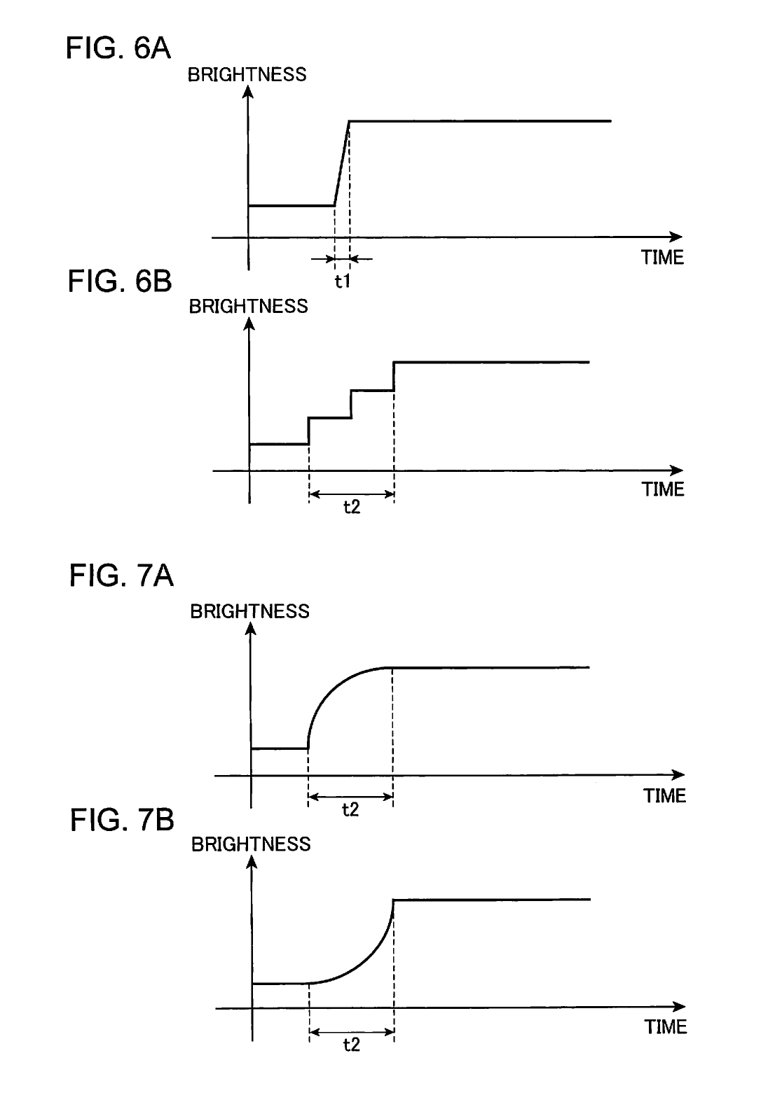

Next, a description is provided of the processing sequence of this variation of the first embodiment. The processing sequence of this variation of the first embodiment differs from the processing sequence of the first embodiment starting in Step S10 in FIG. 4. Therefore, a description of a processing sequence differing from the processing sequence of the above-described first embodiment is provided using FIGS. 6 to 8.

FIGS. 6A and 6B are charts indicating a relationship between the luminance control time and the brightness (luminance). In FIGS. 6A and 6B, time is plotted on the horizontal axis while brightness (luminance) of a divided area is plotted on the vertical axis.

FIG. 6A indicates, in the area luminance time change control unit 8 described above, a control of the LED backlight 3 in the case where the moved amount is determined to be equal to or greater than the predetermined threshold value α and the number of the undetectable motion vectors is determined to be equal to or greater than the predetermined threshold value β, that is, in the case where the input image is a moving image and a switch in the image scene and the like have occurred. On the other hand, FIG. 6B indicates, in the moved amount detection unit 7 described above, a control of the LED backlight 3 in the case where the moved amount is determined to be less than the predetermined threshold value α, that is, in the case where the input image is a still image.

As shown in FIG. 6A, in the case where the input image signal is a moving image and a switch in the image scene and the like have occurred, a time t1 is required for the luminance value of the LED backlight 3 to reach a desired luminance value. In FIG. 6A, the luminance value of the LED backlight 3 changes precipitously until it reaches the desired luminance value (reference luminance value).

On the other hand, as shown in FIG. 6B, in the case where the input image signal is a still image, a time t2 is required for the luminance value of the LED backlight 3 to reach a desired luminance value. In FIG. 6B, the luminance value of the LED backlight 3 changes in a stepwise manner until it reaches the desired luminance value (reference luminance value).

For example, since the time t1 is the time required for the brightness of the LED to change, it is extremely short, and a time about 1/10 or 1/100, for example, of the time during which a single frame is displayed is conceivable. In addition, as the time t2, a time about 2 to 10 times, for example, of the duration of the time t1 is conceivable.

As is clear from FIGS. 6A and 6B, the time t2 until the desired luminance value is reached in the case where the input image signal is a still image is set to be longer than the time t1 until the desired luminance value is reached in the case where the input image signal is a moving image and a switch in the image scene and the like have occurred.

Furthermore, although the method for converting luminance control time is described in the present embodiment for the two cases shown in FIGS. 6A and 6B in order to simplify the description, the present invention is not limited thereto. The luminance control time can also be converted as shown in FIGS. 7A and 7B.

FIGS. 7A and 7B are charts indicating a different relationship between the luminance control time and the brightness (luminance). Specifically, in FIG. 6B, the luminance value is changed in a stepwise manner during the time t2 until the luminance value of the LED backlight 3 reaches the desired luminance value. In contrast, in FIGS. 7A and 7B, the luminance value changes in a non-step manner during the time t2 until the luminance value of the LED backlight 3 reaches the desired luminance value.

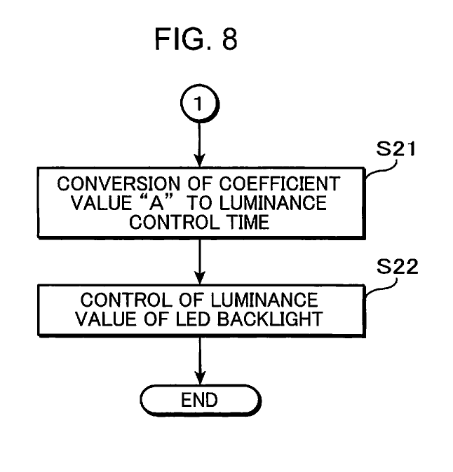

Next, a description is provided of the processing sequence of the variation of the first embodiment with reference to FIG. 8. FIG. 8 is a flow chart showing an example of the operation of a liquid crystal display apparatus in the variation of the first embodiment. Furthermore, since processing through the Step S9 described above duplicates that of the above-described first embodiment, a description thereof is omitted.

In the processing sequence of this variation of the first embodiment, the moved amount analysis unit 9 converts the coefficient value “A” calculated in Steps S5, S8 and S9 to a luminance control time of the LED backlight 3 based on a conversion table set in the manner of the relationship shown in FIGS. 6A and 6B (Step S21). In other words, the luminance control time in the case where “0” is set as the coefficient value “A”, is set to be longer than the luminance control time in the case where “1” is set as the coefficient value “A”, and in the case where “0.1” to “0.9” is set as the coefficient value “A”, the luminance control time is set to become longer as the coefficient value becomes smaller.

Next, the LED backlight drive circuit 4 controls the luminance of the LED of each divided area based on the luminance control time of the LED backlight set in Step S21 (Step S22).

As a result of the operation of the liquid crystal display apparatus as described above, it becomes possible to control the LED backlight 3, inhibiting rapid time-based changes in luminance value in the case where the input image is a still image, and with a suitable luminance value in the case where the input image is a moving image with quick and rushed movements and in the case where the image scene is switched.

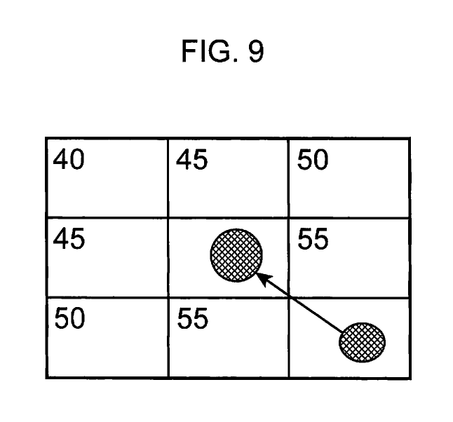

Next, a more detailed description is provided of the specific processing contents of display processing in the case of applying the liquid crystal display apparatus according to this variation of the first embodiment with reference to FIGS. 9 to 14. Here, FIGS. 9 to 11 indicate the case in which the input image is a moving image with quick and rushed movements, while FIGS. 12 to 14 indicate the case in which the input image is a moving image with a little movement.

FIG. 9 is a schematic diagram depicting an object moving across a boundary between the divided areas in a certain input image. In the input image of FIG. 9, the object moves from a divided area in the lower right portion of the screen to a divided area in the central portion of the screen across a boundary between the divided areas.

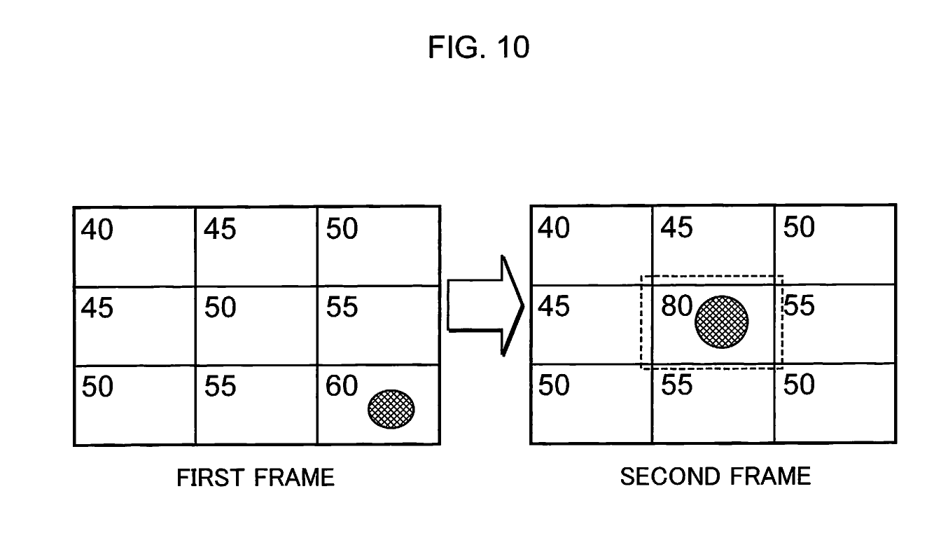

In addition, FIG. 10 is a diagram showing the locations of the object for each frame of the input image of FIG. 9 and the luminance value of each divided area in those frames. In FIG. 10, the frame in which the object is present in the divided area in the lower right portion of the screen is designated as a first frame, while the frame following the first frame in which the object is present in the divided area in the central portion of the screen is designated as a second frame. The first frame and the second frame are continuous in terms of time. In addition, the values such as “40”, “45”, “50”, “55” and “60” shown in the upper left corner of each divided area in FIGS. 9 and 10 indicate the luminance value of each divided area.

As shown in FIG. 10, in the first frame, the object is present in the divided area in the lower right portion of the screen, and the luminance value of the divided area in the lower right portion at this time is “60”. In addition, in the first frame, the luminance value of the divided area in the central portion of the screen is “50”. Next, in the second frame, the object is present in the divided area in the central portion of the screen, and the luminance value of the divided area in the central portion of the screen at this time is “80”.

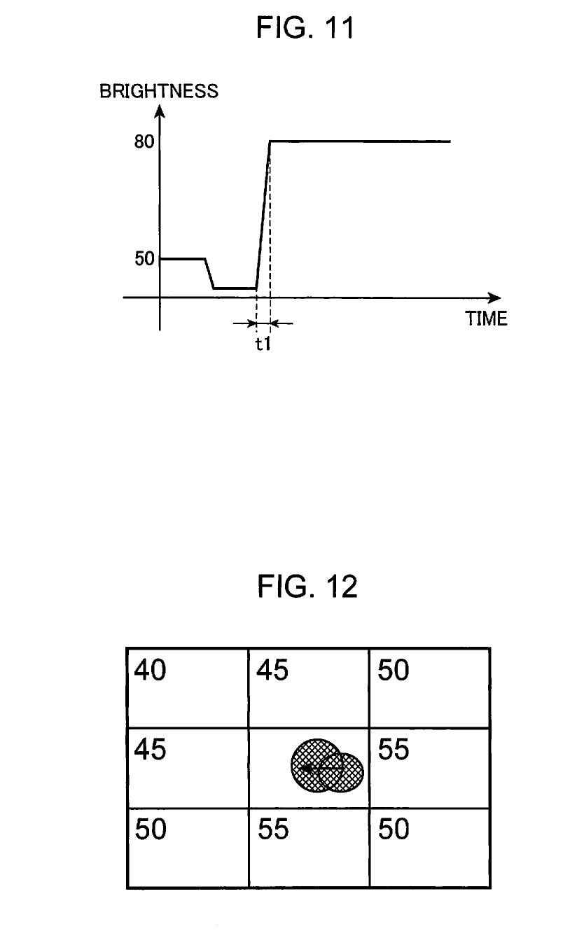

FIG. 11 is a chart indicating the luminance control time of LED backlight in the divided area in the central portion of the screen shown in FIG. 10. As is clear from FIG. 11, the luminance value of the divided area in the central portion of the screen in the first frame is “50”. In the second frame, the LED backlight 3 is controlled so that the luminance value of the divided area in the divided area in the central portion of the screen reaches “80” during the time t1.

FIG. 12 is a schematic diagram depicting an object in a certain input image moving without crossing a boundary between the divided areas. In the input image of FIG. 12, the object moves within the divided area in the central portion of the screen without crossing a boundary between the divided areas.

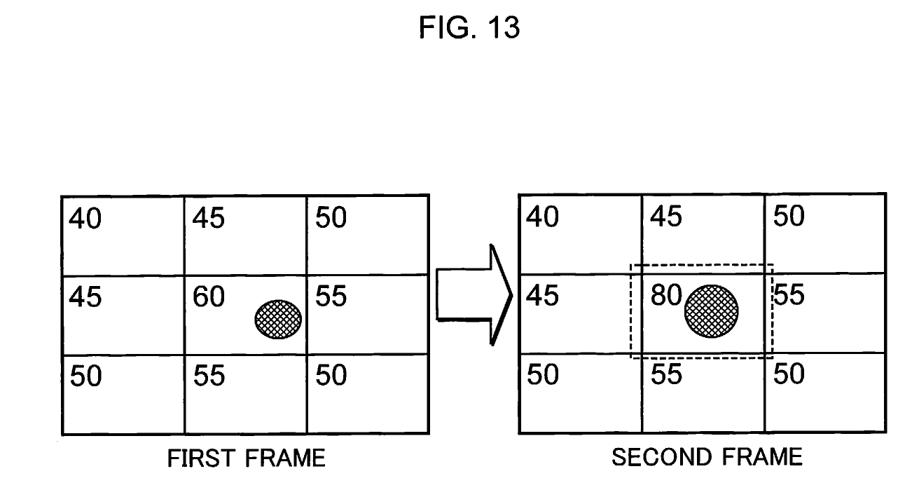

In addition, FIG. 13 is a diagram showing the locations of the object for each frame of the input image of FIG. 12 and the luminance value of each divided area in those frames. In FIG. 13, the frame in which the object is present in the divided area in the central portion of the screen is designated as the first frame, while the frame following the first frame in which the object is present in the central portion of the screen is designated as the second frame. The first frame and the second frame are continuous in terms of time. In addition, the values such as “40”, “45”, “50”, “55” and “60” shown in the upper left corner of each divided area in FIGS. 12 and 13 indicate the luminance value of each divided area.

As shown in FIG. 13, in the first frame, the object is present in the divided area in the central portion of the screen, and the luminance value of the divided area in the central portion at this time is “60”. Next, in the second frame, the object is present in the divided area of the central portion of the screen in the same manner as the first frame, and the luminance value of the divided area in the central portion of the screen at this time is “80”.

FIG. 14 is a chart indicating the luminance control time of LED backlight in the divided area in the central portion of the screen shown in FIG. 13. As is clear from FIG. 14, the luminance value of the divided area in the central portion of the screen in the first frame is “60”. In the second frame, the LED backlight 3 is controlled so that the luminance value of the divided area in the central portion of the screen reaches “80” during the time t2.

Here, when a comparison is made between FIGS. 11 and 14, although both divided areas in the central portion of the screen of the second frame demonstrate equal luminance value of “80”, in contrast to the luminance value of “80” being demonstrated at this time in a comparatively short time (time t1) in the case of FIG. 11, in the case of FIG. 14, the luminance value of “80” is demonstrated in a comparatively long time (time t2).

In this manner, in the case of applying the liquid crystal display apparatus of this variation of the first embodiment, even in the case where the same luminance value is demonstrated for moving images and still images, in the case where the input image is a still image or in the case where the input image is a moving image with a gradual movement, it is possible to inhibit rapid time-based changes in the luminance value (FIG. 14), while in the case where the input image is a moving image with quick and rushed movements, it is possible to control the luminance value of the LED backlight 3 at a suitable time-based change corresponding to the movement (FIG. 11). In addition, in the case where the input image is a switch in the image scene, in the case where the input image is an appearance of the object in an image frame, or in the case where the input image is a disappearance of the object from an image frame, the luminance value can be rapidly changed.

### Second Embodiment

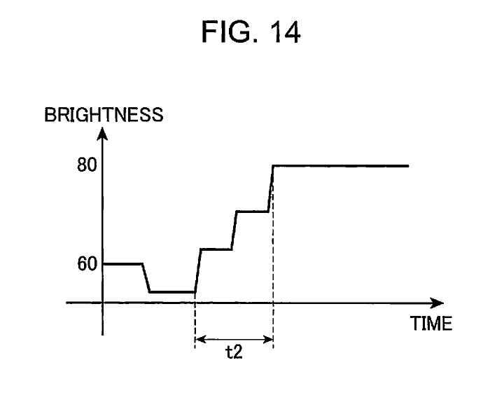

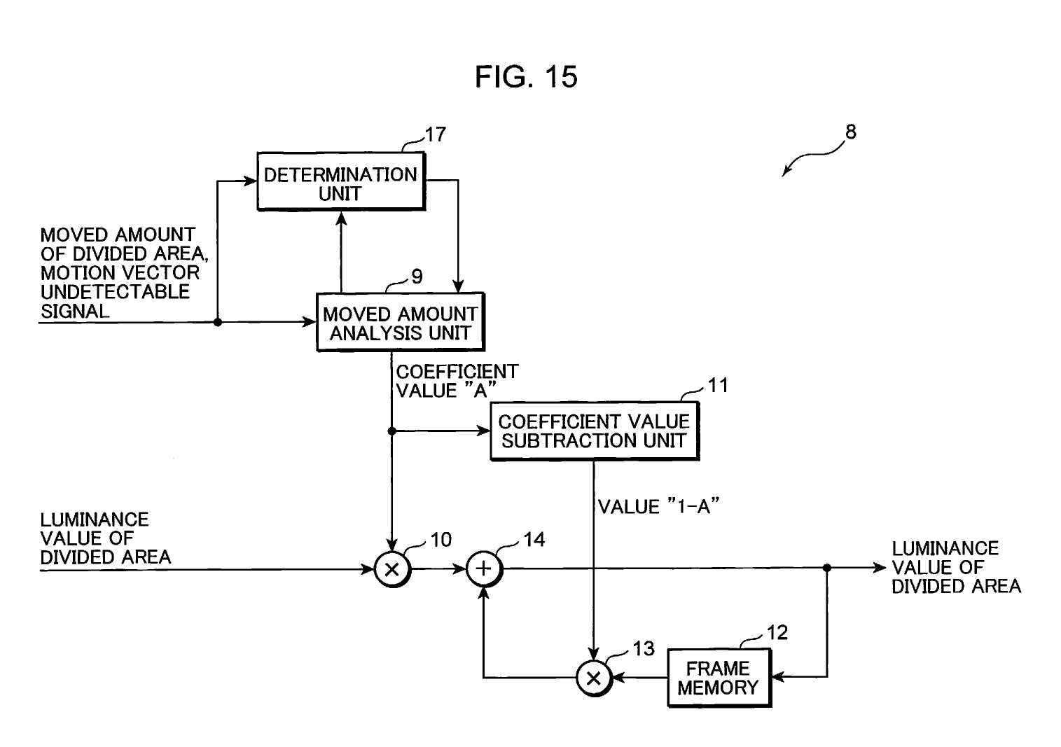

FIG. 15 is a block diagram showing a detailed configuration of the area luminance time change control unit 8 in a liquid crystal display apparatus of a second embodiment. Furthermore, a description of the entire configuration of the liquid crystal display apparatus of the second embodiment is omitted since it is the same as the liquid crystal display apparatus shown in FIG. 1. In addition, the same reference symbols are used in FIG. 15 to indicate those constituents that are the same as those of the area luminance time change control unit 8 shown in FIG. 2, and descriptions thereof are omitted.

In the case where the moved amount detected by the moved amount detection unit 7 has been determined to be equal to or greater than a predetermined value, the area luminance time change control unit 8 shown in FIG. 15 counts the motion vectors in a divided area that cannot be detected by the moved amount detection unit 7 as undetectable motion vectors, and determines whether or not the number of the undetectable motion vectors is equal to or greater than a predetermined value. In the case where the number of the undetectable motion vectors has been determined not to be equal to or greater than the predetermined value, the area luminance time change control unit 8 determines whether or not an object has moved across a boundary between the divided areas based on the moved amount detected by the moved amount detection unit 7. In the case where the object has been determined to have moved across a boundary between the divided areas, the area luminance time change control unit 8 makes the luminance control time shorter than the luminance control time in the case where the object has not moved across a boundary between the divided areas.

The area luminance time change control unit 8 of the second embodiment is provided with the moved amount analysis unit 9, the first multiplier 10, the coefficient value subtraction unit 11, the frame memory 12, the second multiplier 13, the adder 14 and a determination unit 17. The liquid crystal display apparatus of the second embodiment is further provided with the determination unit 17 in the area luminance time change control unit 8 of the first embodiment.

The determination unit 17 determines whether or not an object has moved across a boundary between the divided areas based on the moved amount detected by the moved amount detection unit 7. The determination unit 17 determines whether or not an object in a prescribed divided area of an input image signal moves across a boundary between the divided areas by comparing the moved amount of a prescribed divided area detected by the moved amount detection unit 7 and a preliminarily detected size of the divided area. More specifically, the determination unit 17 compares the moved amount of a prescribed divided area detected by the moved amount detection unit 7 with a preliminarily detected size of the divided area. The determination unit 17 determines that the object within the prescribed divided area has moved across a boundary between the divided areas in the case where the moved amount exceeds the size of the divided area. The determination unit 17 determines that the object within the prescribed divided area has not moved across a boundary between the divided areas in the case where the moved amount does not exceed the size of the divided area.

In a case like that shown in FIG. 9, the determination unit 17 determines that the object in the divided area has moved across a boundary between the divided areas. On the other hand, in a case like that shown in FIG. 12, the determination unit 17 determines that the object in the divided area has not moved across a boundary between the divided areas. Furthermore, although whether or not the object in the divided area has moved across a boundary between the divided areas is determined by comparing the moved amount of the divided area and the size of the divided area in the above description, the present invention is not limited thereto.

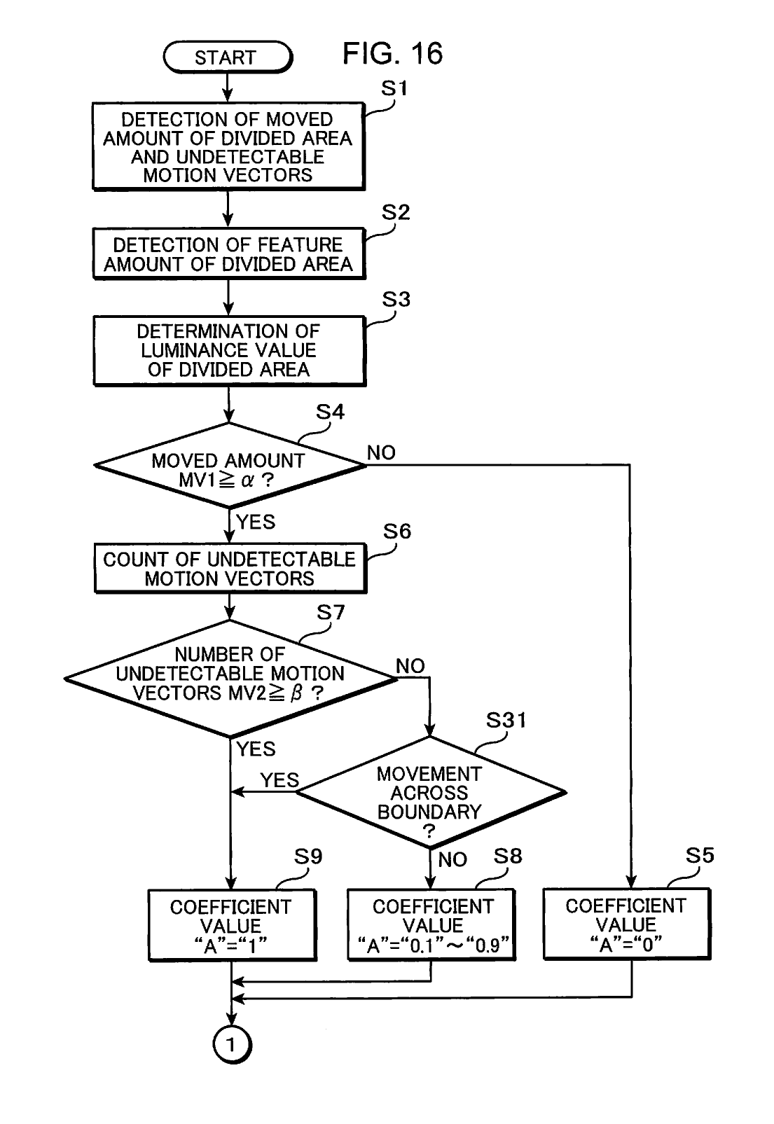

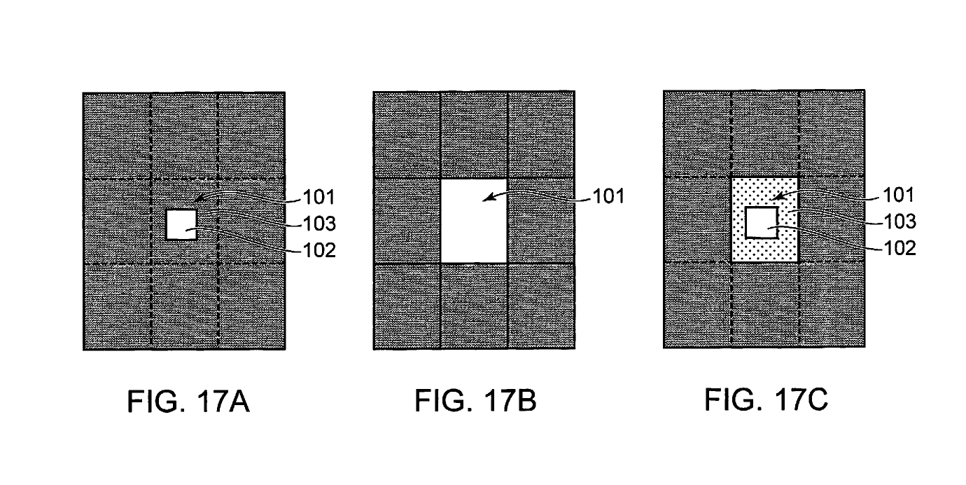

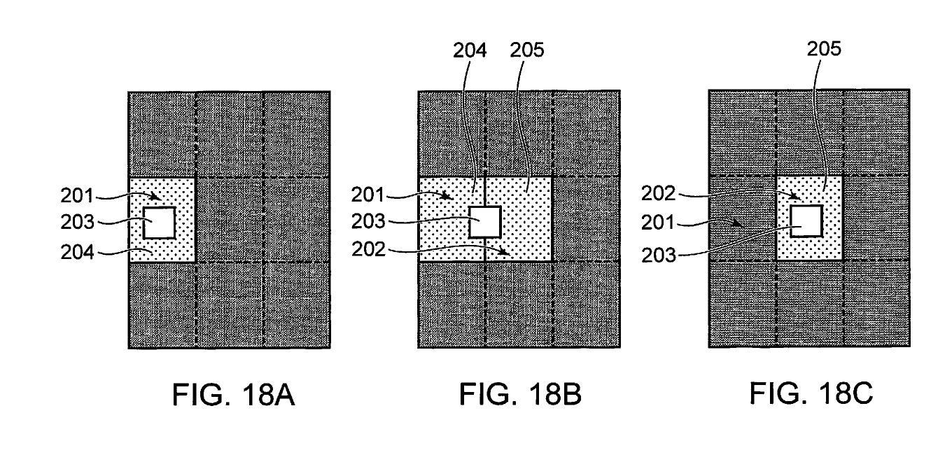

Next, a description is provided of the operation of a liquid crystal display apparatus provided with the determination unit 17 with reference to FIG. 16. FIG. 16 is a flow chart showing an example of the operation of the liquid crystal display apparatus of the second embodiment. Furthermore, since FIG. 16 includes contents that duplicate those of the above described FIG. 3, a description of those duplicate contents is omitted in the present embodiment.

In the case where the number of the undetectable motion vectors in a divided area detected by the moved amount detection unit 7 has been determined to be less than the predetermined threshold value β, that is, in the case where the input image is a moving image and there has been no switch in the image scene and the like (NO in Step S7), the determination unit 17 determines whether or not an object in a prescribed divided area of the input image of the current frame is moving across a boundary between the divided areas from another divided area of the input image of the previous frame (Step S31).

Here, in the case where the object has been determined to be moving across a boundary between the divided areas (YES in Step S31), the moved amount analysis unit 9 assigns “1” as the coefficient value “A” (Step S8). On the other hand, in the case where the object has been determined not to be moving across a boundary between the divided areas (NO in Step S31), the moved amount analysis unit 9 assigns a value of “0.1” to “0.9” corresponding to the moved amount as the coefficient value “A” (Step S5). Furthermore, a description of operation starting in Step S9 and beyond is omitted since it is the same as that of the above described first embodiment or the variation of the first embodiment.

As a result of this processing, in the case of applying the liquid crystal display apparatus of the second embodiment, rapid time-based changes in luminance value can be inhibited in the case where the object does not cross a boundary between the divided areas, and the LED backlight 3 can be controlled at a suitable luminance value corresponding to a rapid change in the luminance value in the case where the object crosses a boundary between the divided areas.

Furthermore, the above-described display control method of the liquid crystal display apparatus is merely one example of the invention of the present application, and in the case where similar effects are obtained, other display control methods may be employed.

Furthermore, inventions having the following configurations are mainly included in the specific embodiments described above.

A display apparatus according to one aspect of the present invention is provided with an illumination light source that illuminates each of a plurality of divided image areas of a screen, a moved amount detection unit that detects a moved amount of an input image in each of the image areas, a reference luminance value determination unit that determines a reference luminance value for each of the image areas, a luminance control time determination unit that determines a luminance control time required to reach the reference luminance value determined by the reference luminance value determination unit for each of the image areas, according to the moved amount detected by the moved amount detection unit, and a drive unit that drives the illumination light source based on the luminance control time for each of the image areas determined by the luminance control time determination unit.

According to this configuration, the illumination light source illuminates each of a plurality of divided image areas of a screen. The moved amount detection unit detects a moved amount of an input image in each of the image areas. The reference luminance determination unit determines a reference luminance value for each of the image areas. The luminance control time determination unit determines a luminance control time required to reach the reference luminance value determined by the reference luminance value determination unit for each of the image areas, according to the moved amount detected by the moved amount detection unit. The drive unit drives the illumination light source based on the luminance control time for each of the image areas determined by the luminance control time determination unit.

Accordingly, the luminance control time required to reach the determined reference luminance value is determined for each of the image areas according to the detected moved amount. Thus, it is possible to prevent the brightened black by inhibiting rapid changes in luminance value of the illumination light in the case where the input image is a still image, and to change the luminance value of the illumination light according to the moved amount in the case where the input image is a moving image having a large moved amount, thereby making it possible to improve display quality of the image.

In addition, in the above-described display apparatus, it is preferred that the luminance control time determination unit determines whether or not the moved amount detected by the moved amount detection unit is equal to or greater than a predetermined value, and makes, when determining that the moved amount detected by the moved amount detection unit is not equal to or greater than the predetermined value, the luminance control time longer than the luminance control time in the case where the moved amount detected by the moved amount detection unit is determined to be equal to or greater than the predetermined value.

According to this configuration, whether or not the moved amount detected by the moved amount detection is equal to or greater than a predetermined value is determined, and in the case where the moved amount is determined not to be equal to or greater than the predetermined value, the luminance control time required to reach a reference luminance value is determined so as to be longer than the luminance control time required to reach the reference luminance value in the case where the moved amount is determined to be equal to or greater than the predetermined value.

Thus, the luminance control time required to reach the reference luminance value can be properly controlled according to whether an input image is a still image or a moving image of which a moved amount is large.

In addition, in the above-described display apparatus, it is preferred that the moved amount detection unit detects a motion vector in each of a plurality of microareas obtained by further dividing each of the image areas, and detects the moved amount of each of the image areas based on the detected motion vector, and that the luminance control time determination unit counts, when determining that the moved amount detected by the moved amount detection unit is equal to or greater than the predetermined value, motion vectors in the image areas that cannot be detected by the moved amount detection unit as undetectable motion vectors, determines whether or not a number of the undetectable motion vectors is equal to or greater than a predetermined value, and makes, when determining that the number of the undetectable motion vectors is not equal to or greater than the predetermined value, the luminance control time longer than the luminance control time in the case where the number of the undetectable motion vectors is determined to be equal to or greater than the predetermined value.

According to this configuration, the moved amount detection unit detects a motion vector in each of a plurality of microareas obtained by further dividing each of the image areas, and detects the moved amount of each of the image areas based on the detected motion vector. In the case where the moved amount is determined to be equal to or greater than the predetermined value, motion vectors in the image area that cannot be detected by the moved amount detection unit are counted as undetectable motion vectors. Subsequently, a determination is made as to whether or not the number of undetectable motion vectors is equal to or greater than a predetermined value. In the case where the number of the undetectable motion vectors is determined not to be equal to or greater than the predetermined value, the luminance control time required to reach the reference luminance value is determined so as to be longer than the luminance control time required to reach the reference luminance value in the case where the number of the undetectable motion vectors is determined to be equal to or greater than the predetermined value.

Motion vectors are not detected in the case where the image scene has switched, an object has suddenly appeared in an image frame, or an object has suddenly disappeared from an image frame. Thus, by counting the number of the undetectable motion vectors, an image within the image area can be determined to be an image scene that has switched, an image scene in which an object has suddenly appeared, or an image scene from which an object has suddenly disappeared, and the luminance control time required to reach the reference luminance value can be suitably controlled according to the result of this determination.

In addition, in the above-described display apparatus, it is preferred that the moved amount detection unit detects a motion vector in each of a plurality of microareas obtained by further dividing each of the image areas, and detects the moved amount of each of the image areas based on the detected motion vector, and that the luminance control time determination unit counts, when determining that the moved amount detected by the moved amount detection unit is equal to or greater than the predetermined value, motion vectors in the image areas that cannot be detected by the moved amount detection unit as undetectable motion vectors, determines whether or not a number of the undetectable motion vectors is equal to or greater than a predetermined value, determines, when determining that the number of the undetectable motion vectors is not equal to or greater than the predetermined value, whether or not an object has moved across a boundary between the image areas based on the moved amount detected by the moved amount detection unit, and makes, when determining that the object has moved across the boundary between the image areas, the luminance control time shorter than the luminance control time in the case where the object is determined not to have moved across the boundary between the image areas.

According to this configuration, the moved amount detection unit detects a motion vector in each of a plurality of microareas obtained by further dividing each of the image areas, and detects the moved amount of each of the image areas based on the detected motion vector. In the case where the moved amount is determined to be equal to or greater than the predetermined value, motion vectors within the image area that cannot be detected by the moved amount detection unit are counted as undetectable motion vectors. Subsequently, a determination is made as to whether or not the number of the undetectable motion vectors is equal to or greater than a predetermined value. In the case where the number of the undetectable motion vectors is determined not to be equal to or greater than the predetermined value, a determination is made as to whether or not an object has moved across a boundary between the image areas based on the moved amount detected by the moved amount detection unit. In the case where the object is determined to have moved across the boundary between the image areas, the luminance control time required to reach the reference luminance value is determined so as to be shorter than the luminance control time required to reach the reference luminance value in the case where the object is determined not to have moved across the boundary between the image areas.

Thus, in the case where the object has not crossed the boundary between the image areas, rapid time-based changes in the luminance value can be inhibited, while in the case where the object has crossed the boundary between the image areas, the illumination light source can be controlled at a suitable luminance value corresponding to the moved amount.

In addition, in the above-described display apparatus, it is preferred that a storage unit is further provided that stores at least the reference luminance value for each of the image areas of an input image which has been input in a previous frame, and that the luminance control time determination unit sets the luminance control time based on the reference luminance value of each of the image areas of the input image of the previous frame stored in the storage unit, when determining that the moved amount detected by the moved amount detection unit is not equal to or greater than the predetermined value, and sets the luminance control time based on the reference luminance value of each of the image areas of a current input image and the reference luminance value of each of the image areas of the input image of the previous frame stored in the storage unit, when determining that the moved amount detected by the moved amount detection unit is equal to or greater than the predetermined value.

According to this configuration, the storage unit stores at least the reference luminance value for each of the image areas of an image which has been input in a previous frame. In the case where the detected moved amount is determined not to be equal to or greater than the predetermined value, the luminance control time required to reach the reference luminance value is set based on the reference luminance value of each of the image areas of the input image of the previous frame stored in the storage unit. In addition, in the case where the detected moved amount is determined to be equal to or greater than the predetermined value, the luminance control time required to reach the reference luminance value is set based on the reference luminance value of each of the image areas of the current input image and the reference luminance value of each of the image areas of the input image of the previous frame stored in the storage unit.

Accordingly, in the case where the input image is a still image, the luminance control time required to reach the reference luminance value is set based on the reference luminance value of each of the image areas of the input image of the previous frame instead of the reference luminance value of each of the image areas of the current input image. Thus, time-based changes in the reference luminance value are inhibited, and the luminance control time required to reach the reference luminance value can be prolonged. In addition, in the case where the input image is a moving image, the luminance control time required to reach the reference luminance value is set based on the reference luminance value of each of the image areas of the current input image and the reference luminance value of each of the image areas of the input image of the previous frame. Thus, the ratio at which the current reference luminance value and the reference luminance value of the previous frame are used can be changed according to the moved amount, and the luminance control time required to reach the reference luminance value can be suitably controlled.

In addition, in the above-described display apparatus, it is preferred that a storage unit is further provided that stores at least the reference luminance value for each of the image areas of an input image which has been input in a previous frame, and that the luminance control time determination unit sets the luminance control time based on the reference luminance value of each of the image areas of a current input image, when determining that the number of the undetectable motion vectors is equal to or greater than the predetermined value, and sets the luminance control time based on the reference luminance value of each of the image areas of the current input image and the reference luminance value of each of the image areas of the input image of the previous frame stored in the storage unit, when determining that the number of the undetectable motion vectors is not equal to or greater than the predetermined value.

According to this configuration, the storage unit stores at least the reference luminance value for each of the image areas of an image which has been input in a previous frame. In the case where the number of the undetectable motion vectors is determined to be equal to or greater than the predetermined value, the luminance control time required to reach the reference luminance value is set based on the reference luminance value of each of the image areas of the current input image. In addition, in the case where the number of the undetectable motion vectors is determined not to be equal to or greater than the predetermined value, the luminance control time required to reach the reference luminance value is set based on the reference luminance value of each of the image areas of the current input image and the reference luminance value of each of the image areas of the input image of the previous frame stored in the storage unit.

Accordingly, in the case where the image scene has switched, an object has suddenly appeared in an image frame, or an object has suddenly disappeared from an image frame, the luminance control time required to reach the reference luminance value is set based on the reference luminance value of each of the image areas of the current input image. Thus, time-based changes in the reference luminance value become easy, and the luminance control time required to reach the reference luminance value can be shortened. In addition, in the case where the input image is a moving image, the luminance control time required to reach the reference luminance value is set based on the reference luminance value of each of the image areas of the current input image and the reference luminance value of each of the image areas of the input image of the previous frame. Thus, the ratio at which the current reference luminance value and the reference luminance value of the previous frame are used can be changed according to the moved amount, and the luminance control time required to reach the reference luminance value can be suitably controlled.

A display control method according to another aspect of the present invention is a display control method for controlling an illumination light source that illuminates each of a plurality of divided image areas of a screen, comprising a moved amount detection step of detecting a moved amount of an input image in each of the image areas, a reference luminance value determination step of determining a reference luminance value for each of the image areas, a luminance control time determination step of determining a luminance control time required to reach the reference luminance value determined in the reference luminance value determination step for each of the image areas, according to the moved amount detected in the moved amount detection step, and a drive step of driving the illumination light source based on the luminance control time for each of the image areas determined in the luminance control time determination step.

According to this configuration, the illumination light source illuminates each of a plurality of divided image areas of a screen. The moved amount of the input image in each of the image areas is detected in the moved amount detection step. The reference luminance value is determined for each of the image areas in the reference luminance value determination step. In the luminance control time determination step, the luminance control time required to reach the reference luminance value determined in the reference luminance value determination step is determined for each of the image areas according to the moved amount detected in the moved amount detection step. In the drive step, the illumination light source is driven based on the luminance control time for each of the image areas determined in the luminance control time determination step.

Accordingly, the luminance control time required to reach the determined reference luminance value is determined for each of the image areas according to the detected moved amount. Thus, in the case where the input image is a still image, rapid changes in the luminance value of the illumination light can be inhibited, while in the case where the input image is a moving image with a large moved amount, the luminance value of the illumination light can be changed according to the moved amount and a display quality of the image can be improved.

Furthermore, specific embodiments or examples indicated in the section entitled best mode for carrying out the invention are merely intended to clarify the technical contents of the present invention, and should not be understood in the narrow sense as being limiting, and can be modified in various ways within the scope of the spirit and claims of the present invention.

### INDUSTRIAL APPLICABILITY

The display apparatus and the display control method of the present invention are useful as a display apparatus and a display control method that displays images by modulating irradiated light from an illumination light source with a light modulation element, and can be used in, for example, liquid crystal televisions, liquid crystal monitors, and the like.

1. A display apparatus, comprising:
an illumination light source that illuminates each of a plurality of divided image areas of a screen;
a moved amount detection unit that detects a moved amount of an input image in each of the image areas;
a reference luminance value determination unit that determines a reference luminance value for each of the image areas;
a luminance control time determination unit that determines a luminance control time required to reach the reference luminance value determined by the reference luminance value determination unit for each of the image areas, according to the moved amount detected by the moved amount detection unit; and
a drive unit that drives the illumination light source based on the luminance control time for each of the image areas determined by the luminance control time determination unit.

2. The display apparatus according to claim 1, wherein the luminance control time determination unit determines whether or not the moved amount detected by the moved amount detection unit is equal to or greater than a predetermined value, and makes, when determining that the moved amount detected by the moved amount detection unit is not equal to or greater than the predetermined value, the luminance control time longer than the luminance control time in the case where the moved amount detected by the moved amount detection unit is determined to be equal to or greater than the predetermined value.

3. The display apparatus according to claim 2, wherein
the moved amount detection unit detects a motion vector in each of a plurality of microareas obtained by further dividing each of the image areas, and detects the moved amount of each of the image areas based on the detected motion vector, and
the luminance control time determination unit counts, when determining that the moved amount detected by the moved amount detection unit is equal to or greater than the predetermined value, motion vectors in the image areas that cannot be detected by the moved amount detection unit as undetectable motion vectors, determines whether or not a number of the undetectable motion vectors is equal to or greater than a predetermined value, and makes, when determining that the number of the undetectable motion vectors is not equal to or greater than the predetermined value, the luminance control time longer than the luminance control time in the case where the number of the undetectable motion vectors is determined to be equal to or greater than the predetermined value.

4. The display apparatus according to claim 2, wherein
the moved amount detection unit detects a motion vector in each of a plurality of microareas obtained by further dividing each of the image areas, and detects the moved amount of each of the image areas based on the detected motion vector, and
the luminance control time determination unit counts, when determining that the moved amount detected by the moved amount detection unit is equal to or greater than the predetermined value, motion vectors in the image areas that cannot be detected by the moved amount detection unit as undetectable motion vectors, determines whether or not a number of the undetectable motion vectors is equal to or greater than a predetermined value, determines, when determining that the number of the undetectable motion vectors is not equal to or greater than the predetermined value, whether or not an object has moved across a boundary between the image areas based on the moved amount detected by the moved amount detection unit, and makes, when determining that the object has moved across the boundary between the image areas, the luminance control time shorter than the luminance control time in the case where the object is determined not to have moved across the boundary between the image areas.

5. The display apparatus according to claim 2, further comprising a storage unit that stores at least the reference luminance value for each of the image areas of an input image which has been input in a previous frame, wherein
the luminance control time determination unit sets the luminance control time based on the reference luminance value of each of the image areas of the input image of the previous frame stored in the storage unit, when determining that the moved amount detected by the moved amount detection unit is not equal to or greater than the predetermined value, and sets the luminance control time based on the reference luminance value of each of the image areas of a current input image and the reference luminance value of each of the image areas of the input image of the previous frame stored in the storage unit, when determining that the moved amount detected by the moved amount detection unit is equal to or greater than the predetermined value.

6. The display apparatus according to claim 3, further comprising a storage unit that stores at least the reference luminance value for each of the image areas of an input image which has been input in a previous frame, wherein
the luminance control time determination unit sets the luminance control time based on the reference luminance value of each of the image areas of a current input image, when determining that the number of the undetectable motion vectors is equal to or greater than the predetermined value, and sets the luminance control time based on the reference luminance value of each of the image areas of the current input image and the reference luminance value of each of the image areas of the input image of the previous frame stored in the storage unit, when determining that the number of the undetectable motion vectors is not equal to or greater than the predetermined value.

7. A display control method for controlling an illumination light source that illuminates each of a plurality of divided image areas of a screen, comprising:
a moved amount detection step of detecting a moved amount of an input image in each of the image areas;
a reference luminance value determination step of determining a reference luminance value for each of the image areas;
a luminance control time determination step of determining a luminance control time required to reach the reference luminance value determined in the reference luminance value determination step for each of the image areas, according to the moved amount detected in the moved amount detection step; and
a drive step of driving the illumination light source based on the luminance control time for each of the image areas determined in the luminance control time determination step.
